(19) United States
(12) Patent Application Publication
(10) Pub. No.: US 2016/0154507 A1
(43) Pub. Date: Jun. 2, 2016

(54) SYSTEMS, METHODS, AND DEVICES FOR TOUCH EVENT AND HOVER EVENT DETECTION

(71) Applicant: Cypress Semiconductor Corporation, San Jose, CA (US)

(72) Inventors: Vibheesh Bharathan, San Jose, CA (US); Peter G. Vavaroutsos, Scotts Valley, CA (US); Jinghui Mu, San Jose, CA (US)

(73) Assignee: Cypress Semiconductor Corporation, San Jose, CA (US)

(21) Appl. No.: 14/714,118

(22) Filed: May 15, 2015

Related U.S. Application Data
(60) Provisional application No. 62/132,705, filed on Mar. 13, 2015.
(60) Provisional application No. 62/086,091, filed on Dec. 1, 2014.

(51) Int. Cl. G06F 3/047; G06F 3/01; G06F 3/0354; G06F 3/044; G09G 5/00

(52) U.S. Cl. CPC G06F 3/047; G06F 3/044; G09G 5/003; G06F 3/03545; G06F 3/014; G09G 2300/0426

(57) ABSTRACT

Disclosed herein are systems, methods, and devices for touch event and hover event detection. Devices as disclosed herein may include a first electrode implemented in a capacitive sensor. The devices may also include a second electrode implemented in the capacitive sensor. The devices may further include a controller coupled to the first electrode and the second electrode, where the controller is configured to determine whether a touch event or a hover event has occurred based on a first self-capacitance measurement of the first electrode, a second self-capacitance measurement of the second electrode, and a mutual capacitance measurement of the first electrode and the second electrode.

### CROSS-REFERENCE TO RELATED APPLICATIONS

This application claims the benefit under 35 U.S.C. §119(e) of U.S. Provisional Patent Application No. 62/132,705, filed on 2015 Mar. 13, and U.S. Provisional Patent Application No. 62/086,091, filed on 2014 Dec. 1, which are incorporated by reference herein in their entirety for all purposes.

### TECHNICAL FIELD

This disclosure generally relates to capacitive sensors and, more specifically, to hover and touch detection based on capacitive sensors.

### BACKGROUND

Devices and systems, such as mobile communications devices, may include various input devices such as touchscreens and buttons. The touchscreens and buttons may utilize one or more sensing modalities to receive the inputs from an entity, such as a user of a mobile communications device. An example of such a modality may be capacitive sensing in which a touchscreen or button may include conductive elements which may be used to obtain various capacitance measurements. For example, a touchscreen may include an array of electrodes and a touchscreen controller may be used to measure capacitances associated with those electrodes. However, many capacitive sensors remain limited because they are not able to accurately distinguish between different user inputs.

### SUMMARY

Disclosed herein are systems, methods, and devices for touch event and hover event detection. Devices as disclosed herein may include a first electrode implemented in a capacitive sensor. The devices may also include a second electrode implemented in the capacitive sensor. The devices may further include a controller coupled to the first electrode and the second electrode, where the controller is configured to determine whether a touch event or a hover event has occurred based on a first self-capacitance measurement of the first electrode, a second self-capacitance measurement of the second electrode, and a mutual capacitance measurement of the first electrode and the second electrode.

In some embodiments, the controller is further configured to determine whether the touch event or the hover event has occurred based on a comparison of the mutual capacitance measurement with a glove touch threshold value, wherein the touch event is a glove touch event. In various embodiments, the controller is further configured to determine whether the touch event or the hover event has occurred in response to determining that a finger touch event has not occurred, and in response to determining that a stylus touch event has not occurred. In various embodiments, the controller is further configured to determine whether a finger touch event has occurred based on a comparison of the first self-capacitance measurement with a first finger touch threshold value and a comparison of the second self-capacitance measurement with a second finger touch threshold value. The controller may be further configured to determine whether a stylus touch event has occurred based on a comparison of the first self-capacitance measurement with a first stylus touch threshold value and a comparison of the second self-capacitance measurement with a second stylus touch threshold value, wherein the second stylus touch threshold value is less than the second finger touch threshold value. The controller may also be configured to determine whether the hover event has occurred based on a comparison of a third self-capacitance measurement with a hover threshold value, the third self-capacitance measurement being a measured self-capacitance of a combination of the first electrode and the second electrode.

In various embodiments, the hover event is a glove hover event or a finger hover event. In some embodiments, the controller is further configured to measure the third self-capacitance using a higher sensitivity gain than for the first self-capacitance measurement and the second self-capacitance measurement. Moreover, the controller may be implemented, at least in part, in a reprogrammable logic block. In some embodiments, the controller is configured to be reprogrammed to implement different types of measurements, the types of measurements being self-capacitance measurements and mutual capacitance measurements. In various embodiments, the first electrode includes a first plurality of sensing elements, and the second electrode includes a second plurality of sensing elements. In some embodiments, a first geometry of the first electrode and a second geometry of the second electrode are configured based on a mutual capacitance parameter associated with the capacitive sensor. In various embodiments, a position of the second electrode relative to the first electrode is configured based on the mutual capacitance parameter associated with the capacitive sensor.

Also disclosed herein are methods that may include measuring a first self-capacitance of a first electrode and measuring a second self-capacitance of a second electrode. The methods may further include measuring a mutual capacitance between the first electrode and the second electrode, and determining, using a controller, whether a touch event or a hover event has occurred based on the first self-capacitance, the second self-capacitance, and the mutual capacitance. In some embodiments, the touch event is a glove touch event, and the determining whether the touch event or the hover event has occurred further includes comparing the mutual capacitance with a glove touch threshold value.

In some embodiments, the methods further include determining, using the controller, whether a finger touch event has occurred. The determining of the finger touch event may include comparing the first self-capacitance with a first finger touch threshold value, and comparing of the second self-capacitance with a second finger touch threshold value. The methods may also include determining, using the controller, whether a stylus touch event has occurred. The determining of the stylus touch event may include comparing the first self-capacitance with a first stylus touch threshold value, and comparing the second self-capacitance with a second stylus touch threshold value, where the second stylus touch threshold value is less than the second finger touch threshold value. In some embodiments, the determining whether the touch event or the hover event has occurred is responsive to determining that a finger touch event has not occurred, and is responsive to determining that a stylus touch event has not occurred.

In various embodiments, the methods further include measuring a third self-capacitance of a combination of the first electrode and the second electrode, and determining, using the controller, whether a hover event has occurred based on the third self-capacitance. Moreover, the hover event may be a glove hover event or a finger hover event. In some embodiments, the methods further include identifying, using the controller, a hardware failure comprising an operational failure associated the first electrode or the second electrode.

Also disclosed herein are systems that may include a first electrode implemented in a capacitive sensor of a button, and a second electrode implemented in the capacitive sensor of the button. The systems may also include a button controller coupled to the first electrode and the second electrode. In various embodiments, the button controller is configured to report a glove touch event based on a first self-capacitance measurement of the first electrode, a second self-capacitance measurement of the second electrode, and a mutual capacitance measurement of the first electrode and the second electrode. In various embodiments, the first electrode is an inner electrode included in the capacitive sensor of the button, and the second electrode is an outer electrode included in the capacitive sensor of the button. In some embodiments, the button controller is further configured to determine whether or not the glove touch has occurred based on a comparison of the mutual capacitance measurement with a glove touch threshold value. In some embodiments, the button controller is further configured to determine whether or not the glove touch has occurred in response to determining that a finger touch event has not occurred, and in response to determining that a stylus touch event has not occurred.

In various embodiments, the button controller is further configured to determine whether or not a finger touch event has occurred based on a comparison of the first self-capacitance measurement with a first finger touch threshold value and a comparison of the second self-capacitance measurement with a second finger touch threshold value. The button controller may be further configured to determine whether or not a stylus touch event has occurred based on a comparison of the first self-capacitance measurement with a first stylus touch threshold value and a comparison of the second self-capacitance measurement with a second stylus touch threshold value, wherein the second stylus touch threshold value is less than the second finger touch threshold value. The button controller may also be configured to determine whether or not a hover event has occurred based on a comparison of a third self-capacitance measurement with a hover threshold value, the third self-capacitance measurement being a measured self-capacitance of a combination of the first electrode and the second electrode.

Details of one or more embodiments of the subject matter described in this specification are set forth in the accompanying drawings and the description below. Other features, aspects, and advantages will become apparent from the description, the drawings, and the claims.

### BRIEF DESCRIPTION OF THE DRAWINGS

FIG. 1 illustrates a diagram of an example of a capacitive sensing device, implemented in accordance with some embodiments.

FIG. 2 illustrates a diagram of another example of a capacitive sensing device, implemented in accordance with some embodiments.

FIG. 3 illustrates a diagram of yet another example of a capacitive sensing device, implemented in accordance with some embodiments.

FIG. 4 illustrates a diagram of another example of a capacitive sensing device, implemented in accordance with some embodiments.

FIG. 5 illustrates a diagram of yet another example of a capacitive sensing device, implemented in accordance with some embodiments.

FIG. 6 illustrates a flow chart of an example of a capacitive sensing method, implemented in accordance with some embodiments.

FIG. 7 illustrates a flow chart of another example of a capacitive sensing method, implemented in accordance with some embodiments.

FIG. 8 illustrates a flow chart of an example of a failure detection method, implemented in accordance with some embodiments.

FIG. 9 illustrates a diagram of an example of a capacitive sensing system, implemented in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific examples, it will be understood that these examples are not intended to be limiting.

Touchscreens and buttons that utilize capacitive sensors to detect user inputs may experience high error rates when attempting to distinguish between different types of inputs. As disclosed herein, inputs may include touch events generated when a conductive entity, which may or may not be covered by an insulator, touches a surface with which a capacitive sensor is implemented. For example, touch events may be user inputs such as a finger touch event in which a finger physically contacts a surface of a touchscreen or button, a stylus touch event in which a stylus physically contacts a surface of a touchscreen or button, a glove touch event in which a gloved finger physically contacts a surface of a touchscreen or button, and a hover event in which a finger, stylus, or gloved finger is located above, but not in physical contact with, a touchscreen or button. Touch events may also be other inputs received from mechanical devices, such as tools and robotic arms. In one example, a capacitive sensor may incorrectly identify a glove touch as a hover because in a glove touch, the finger does not physically contact the touchscreen or button, but is instead held a distance away due to the material of the glove. Accordingly, capacitive sensors have been limited in their ability to properly identify when an input is a touch and when an input is a hover when the conductive entity is covered by an insulator, as may be the case when a user is wearing a glove. Moreover, conductive entities and their associated insulators may vary tremendously in size, material, and construction. More specifically, variability in gloves may further reduce the accuracy of some capacitive sensors.

Furthermore, devices that utilize capacitive sensors are often limited in their ability to detect and identify hardware failures that may occur with such touchscreens and buttons. The manufacture of capacitive sensors implemented in compact form factors, such as those found in mobile communications devices, may include intricate and sensitive lines and buses. If a hardware failure occurs after assembly, devices often are not able to identify the failure or generate any kind of indication that such a failure has occurred.

Accordingly, various systems, methods, and devices disclosed herein provide the accurate identification of touch events and hover events, thus providing accurate and effective distinction between the two. Moreover, systems, methods, and devices disclosed herein also provide for the accurate identification of hardware failures that may occur in touchscreens and buttons used to identify the touch events and hover events. As will be discussed in greater detail below, a controller associated with a capacitive sensor may utilize a combination of self-capacitance measurements and mutual capacitance measurements to accurately distinguish between different types of touch events as well as hover events. Moreover, the controller may utilize either self-capacitance measurements or mutual capacitance measurements to identify whether or not capacitive sensors are functioning properly.

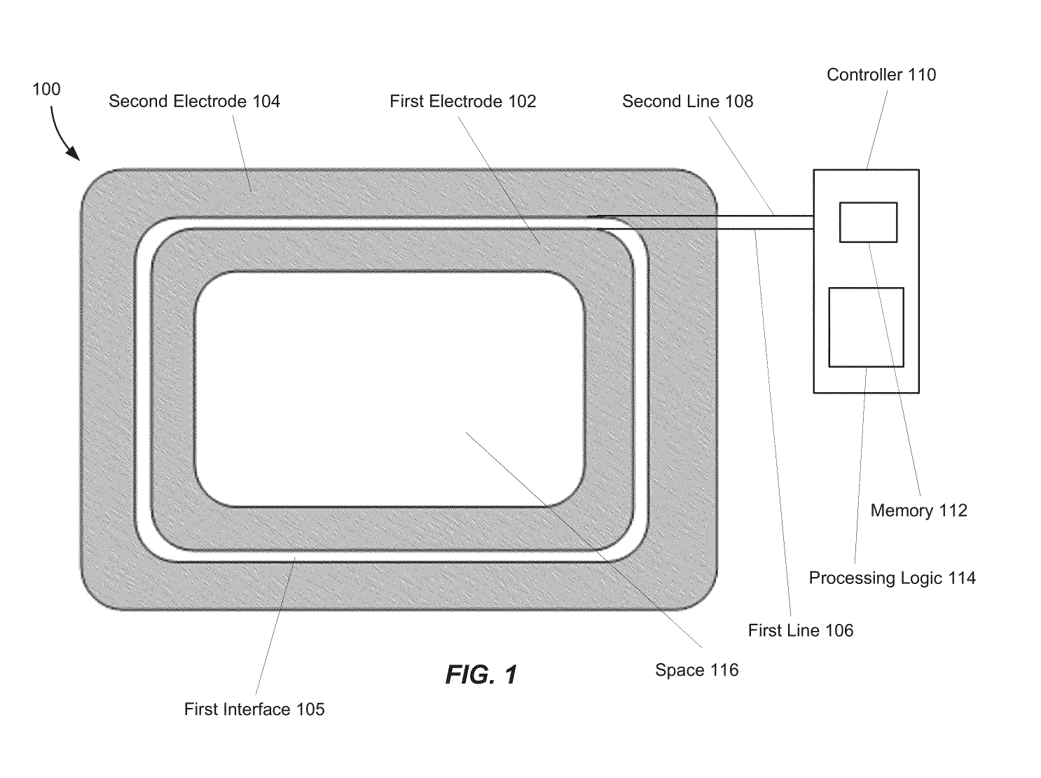

FIG. 1 illustrates a diagram of an example of a capacitive sensing device, implemented in accordance with some embodiments. As discussed above, capacitive sensing devices, systems, and methods as disclosed herein may be capable of effectively distinguishing between various different inputs which may include finger touch events, stylus touch events, glove touch events, and hover events. Accordingly, a capacitive sensing device, such as capacitive sensing device 100 described in greater detail below, may be implemented as a component of a device to enable the use of a capacitive sensing touchscreen or button by a conductive entity which may be mechanical tool, robotic arm, or a user with a bare finger, gloved finger, and/or stylus.

Capacitive sensing device 100 may include first electrode 102 which may be made of an electrically conductive material and may be configured to implement self-capacitance and mutual capacitance measurements, as will be discussed in greater detail below. In various embodiments, first electrode 102 may be made of a conductive material such as indium tin oxide (ITO) and may be implemented as part of a capacitive sensor included in capacitive sensing device 100. Accordingly, first electrode 102 may be configured to have a particular pattern or geometry determined based on an application of capacitive sensing device 100. As shown in FIG. 1, capacitive sensing device 100 may be implemented in a button which may be included in a device such as a mobile communications device or any other suitable device. For example, other devices may include household appliances such as washing machines and dryers. Accordingly, first electrode 102 may be configured to have a geometry contoured to or determined based on a geometry of a button of a mobile communications device, such as a smartphone. In various embodiments, first electrode 102 may also be implemented in a touchscreen of a mobile communications device. Accordingly, while one geometry of first electrode 102 is shown in FIG. 1, various other geometries are contemplated and disclosed herein.

Capacitive sensing device 100 may also include second electrode 104 which may also be made of an electrically conductive material and may be configured to implement self-capacitance and mutual capacitance measurements. As similarly discussed above with reference to first electrode 102, second electrode 104 may also be configured to have a particular pattern or geometry determined based on an application of capacitive sensing device 100 which may be a button or touchscreen of a mobile communications device or other device. In various embodiments, second electrode 104 has a geometry that is similar to or the same as first electrode 102, but with different dimensions. For example, first electrode 102 may have a ring shape, while second electrode 104 also has a ring shape, but with a larger diameter. In this way, first electrode 102 may be positioned within the geometry of second electrode 104, and may be an inner electrode while second electrode 104 is configured to operate as an outer electrode. As will be discussed in greater detail below, a system component, such as controller 110 may be configured to use first electrode 102 and second electrode 104 to make several measurements such as a self-capacitance of first electrode 102, a self-capacitance of second electrode 104, and a mutual capacitance between first electrode 102 and second electrode 104.

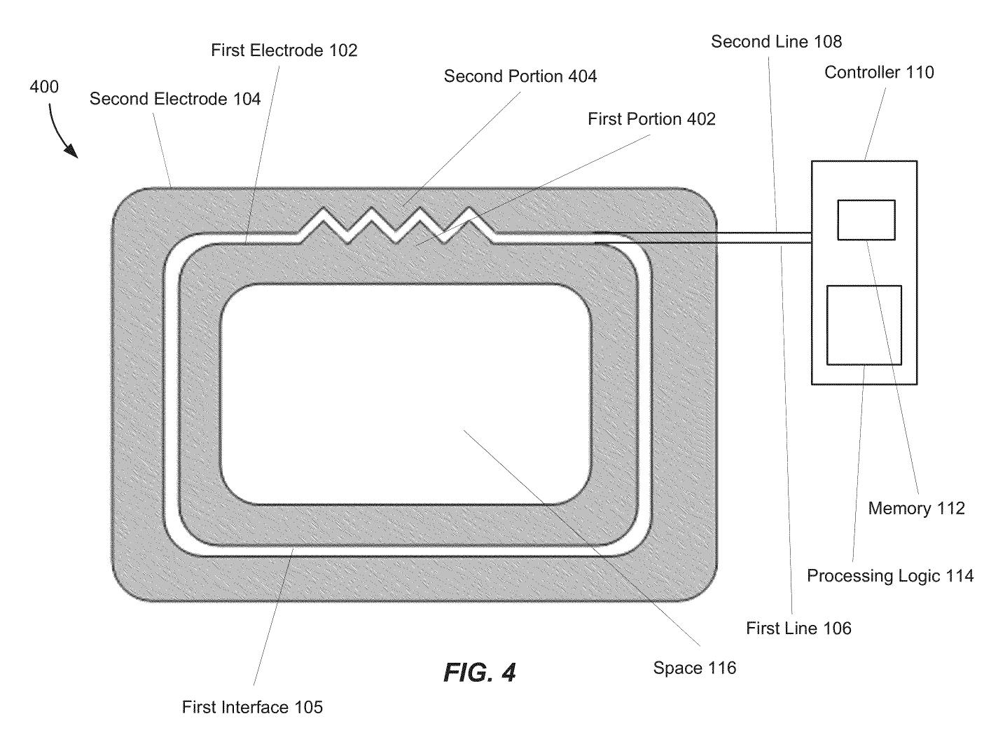

In various embodiments, first interface 105 is implemented between first electrode 102 and second electrode 104. In some embodiments, first interface 105 is a gap or distance between first electrode 102 and second electrode 104. As will be discussed in greater detail below, one or more parameters of first interface 105 may be configured based on performance characteristics and mutual capacitance parameters of capacitive sensing device 100. In some embodiments, first interface 105 may be configured to increase a sensitivity or a magnitude of a mutual capacitance measurement made based on first electrode 102 and second electrode 104, as well as increase an accuracy of determinations of glove touch events and glove hover events, as will be discussed in greater detail below. When configured in this way, capacitive sensing device 100 may be configured to distinguish between touch events and hover events with greater accuracy because a magnitude of the mutual capacitance measurements is increased and enables the more accurate distinction of such measurements from those associated with hover detection. In some embodiments, a distance across first interface 105 may be reduced by positioning first electrode 102 and second electrode 104 relatively close together. In this example, a distance across first interface 105 may be about 0.3 mm or less. Moreover, as will be discussed in greater detail below with reference to FIG. 4, a geometry of first interface 105 may also be configured to increase an accuracy associated with determinations made based, at least in part, on the mutual capacitance measurements.

In various embodiments, capacitive sensing device 100 further includes controller 110 which may be coupled to first electrode 102 and second electrode 104 via first line 106 and second line 108 respectively. In various embodiments, controller 110 is configured to receive signals from first electrode 102 and second electrode 104 as well as apply signals to first electrode 102 and second electrode 104. Accordingly, controller 110 may be configured to measure any or all of a self-capacitance of first electrode 102, a self-capacitance of second electrode 104, a self-capacitance of both first electrode 102 and second electrode 104, and a mutual capacitance between first electrode 102 and second electrode 104. In various embodiments, such measurements are stored in a memory device, such as memory 112, which may be a random access memory (RAM) cell array, or a memory implemented in reprogrammable logic of processing logic 114 discussed in greater detail below. Furthermore, controller 110 may be configured to combine one or more signals from first electrode 102 and second electrode 104. For example, controller 110 may be configured to combine a signal received from first electrode 102 and second electrode 104 and measure a combined self-capacitance generated by both first electrode 102 and second electrode 104, as will be discussed in greater detail below with reference to the determination of hover values.

In various embodiments, controller 110 may include processing logic 114 which may be configured to make one or more determinations based on the previously described measurements. As previously discussed, controller 110 may be included in a device such as a mobile communications device or other device that received inputs from a user that may be using a bare finger, a gloved finger, or a stylus such as a passive stylus. Such inputs may be tactile inputs identified as touch events which may occur when the finger or stylus is touching the touchscreen or button. Such inputs may also be hover inputs identified as hover events which may occur when the finger or stylus is close to, but not touching, a touchscreen or button. The touch events and hover events may also be generated by inputs received from other conductive entities such as mechanical tools and end effectors which may or may not be covered in insulators. Accordingly, based on measurements obtained from signals received from first electrode 102 and second electrode 104, processing logic 114 may be configured to determine various values, which may be data values, that characterize whether or not a particular touch or hover event has occurred. As discussed above and in greater detail below, controller 110 as well as processing logic 114 may be configured to accurately distinguish between touch events generated by a bare conductive entity, touch events generated by a conductive entity covered in an insulator, and hover events generated by any conductive entity. In this way, embodiments disclosed herein enable a user to effectively use a glove finger as well as other instrument, such as a stylus with a capacitive sensor device.

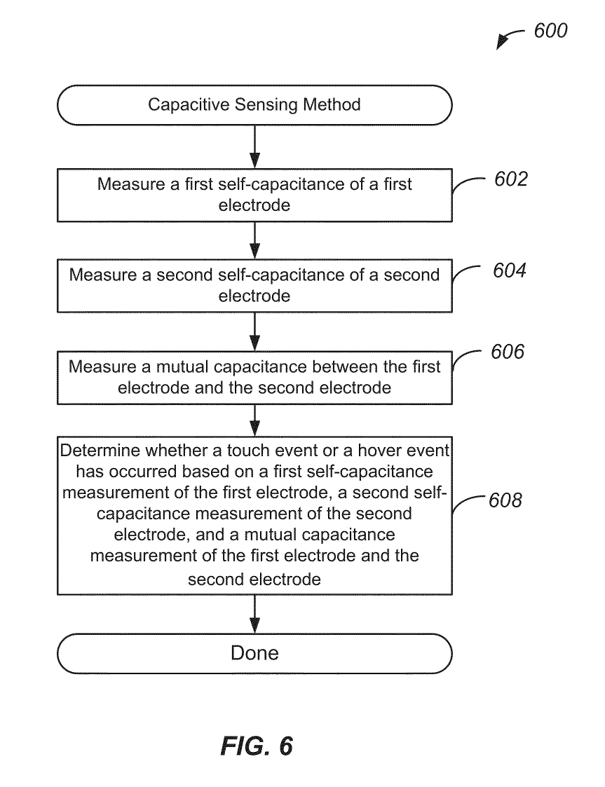

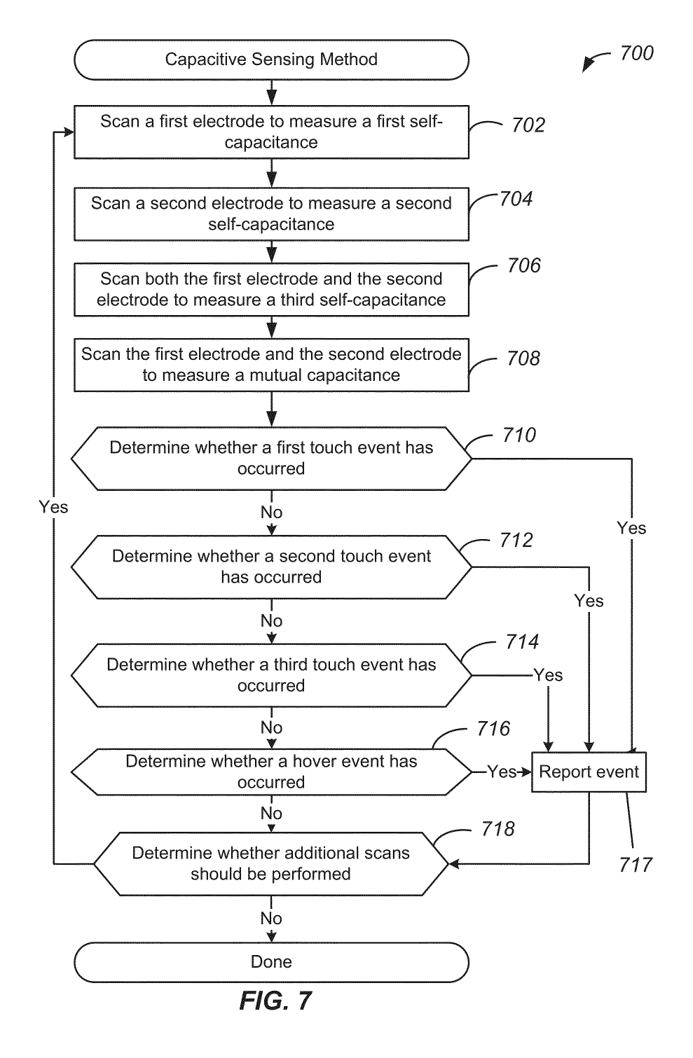

In some embodiments, processing logic 114 may be configured to determine a first touch value, a second touch value, a third touch value, and a hover value based on various different sets of threshold values as well as measurements that will be discussed in greater detail below. For example, processing logic 114 may be configured to determine a glove touch value that characterizes a presence or absence of a glove touch event based on a first self-capacitance measurement of the first electrode, a second self-capacitance measurement of the second electrode, and a mutual capacitance measurement of the first electrode and the second electrode. In various embodiments, controller 110 may store in memory 112 various threshold parameters. As will be discussed in greater detail below with reference to FIG. 6 and FIG. 7, by comparing the measurements with the threshold parameters, processing logic may determine the glove touch value and identify whether or not a glove touch event has occurred. Moreover, processing logic 114 may be further configured to determine a finger touch value characterizing a presence or absence of a finger touch event. In various embodiments, the finger touch may be determined based on self-capacitance measurements of each of first electrode 102 and second electrode 104 and threshold parameters stored in memory 112. Processing logic 114 may also be configured to determine a stylus touch value characterizing a presence or absence of a stylus touch event. In some embodiments, the stylus touch is determined based on self-capacitance measurements of each first electrode 102 and second electrode 104, as well as the threshold parameters stored in memory 112. In some embodiments, a difference between the self-capacitance measurement of first electrode 102 and the self-capacitance measurement of second electrode 104 may also be analyzed. Processing logic 114 may be additionally configured to determine a hover value characterizing a presence or absence of a hover event. In various embodiments, the hover value may be determined based on a self-capacitance measurement of a combination of the first electrode and the second electrode as well as threshold parameters stored in memory 112. Further details of the determination of the glove touch value, finger touch value, stylus touch value, and hover value will be discussed in greater detail below with reference to FIG. 6 and FIG. 7.

In various embodiments, processing logic 114 may be implemented as a reprogrammable logic block. In various embodiments, calculations and computational operations associated with each of the above described processing of measurements may require different processing elements. Accordingly, as will be discussed in greater detail below, processing logic 114 may be dynamically reconfigured to implement any of the above discussed determinations. For example, if different determinations are made in successive order, processing logic 114 may be reconfigured before each determination to implement the subsequent determination. Configuration data controlling the implementation of the reconfiguration of processing logic 114 may be stored in memory 112 as part of an initial setup or configuration process of capacitive sensing device 100. Alternatively, processing logic 114 may be implemented as an application specific integrated chip (ASIC) or some other combination of integrated chips (ICs).

As discussed above, controller 110 may be coupled to first electrode 102 and second electrode 104 via first line 106 and second line 108. In various embodiments, first line 106 and second line 108 are electrically conductive elements, such as lines, buses, or wires. In some embodiments, first line 106 and second line 108 may be made of the same material as first electrode 102 and second electrode 104. Alternatively, first line 106 and second line 108 may be made of a different material. In some embodiments, first line 106 and second line 108 are coupled to pins or ports of controller 110 and are configured to provide bidirectional communication between controller 110 and first electrode 102 and second electrode 104. In this way, controller 110 may receive signals from first electrode 102 and second electrode 104 via first line 106 and second line 108, or may drive first electrode 102 and second electrode 104 with one or more signals via first line 106 and second line 108.

In various embodiments, capacitive sensing device 100 may also include space 116 which may be configured to house or surround an additional element of a touchscreen or button with which capacitive sensing device 100 is implemented. For example, the additional element may be a light emitting diode (LED) that may be configured to provide backlighting. For example, capacitive sensing device 100 may be implemented in a button, and the additional element included in space 116 may be an LED that provides backlighting for the button. In this way, an overall geometry of capacitive sensing device 100 may be configured to match a geometry of another component of the button or touchscreen in which capacitive sensing device 100 is implemented.

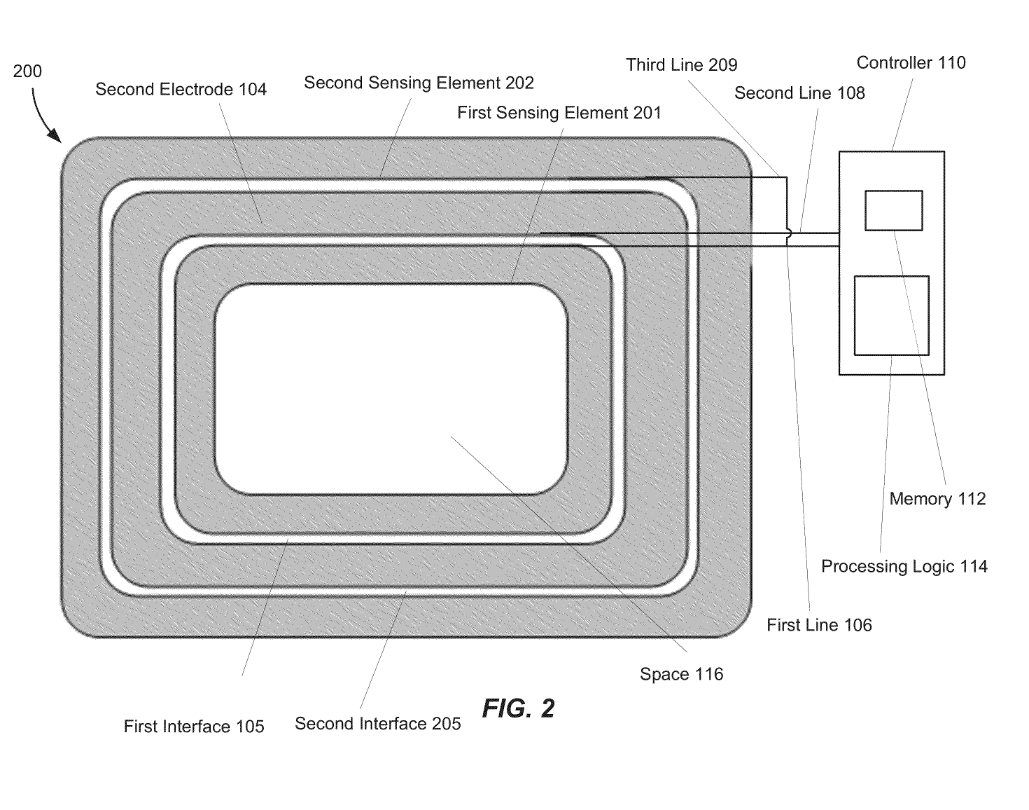

FIG. 2 illustrates a diagram of another example of a capacitive sensing device, implemented in accordance with some embodiments. As similarly discussed above, a capacitive sensing device, such as capacitive sensing device 200 described in greater detail below, may be implemented as a component of a device to enable the use of a capacitive sensing touchscreen or button by a user with a bare finger, gloved finger, and/or stylus or various other configurations of conductive entities. As will be discussed in greater detail below, electrodes may be implemented using several sensing elements to increase an electromagnetic interface between electrodes, and further increase an accuracy of event determinations made based, at least in part, on mutual capacitance measurements. Accordingly, sensing elements may be implemented as components of an electrode, such as several conductive rings included in an electrode.

As discussed above with reference to FIG. 1, capacitive sensing device 200 may include second electrode 104, first interface 105, first line 106, second line 108, controller 110, memory 112, processing logic 114, and space 116. As shown in FIG. 2, the first electrode may include several sensing elements that may be electrically couple together via one or more lines. For example, a first electrode, such as first electrode 102 discussed above, may be implemented using first sensing element 201 and second sensing element 202 which may be coupled together via third line 209, and coupled to controller 110 via second line 108. Accordingly, first sensing element 201 and second sensing element may be configured to have a geometry similar to second electrode 104, but with varying dimensions. In one example, second electrode 104 may be implemented as a ring shape sensing element configured to encircle one or more components of a button, such as an LED placed in space 116. Accordingly, first sensing element 201 may have a similar ring shape, but with a smaller diameter such that first interface 105 exists between first sensing element 201 and second electrode 104. Moreover, second sensing element 202 may also have a similar ring shape, but may have a larger diameter such that second interface 205 exists between second sensing element 202 and second electrode 104. Accordingly, an overall interface between the first electrode and second electrode 104 may be a combination of first interface 105 and second interface 205. In this way, the implementation of additional sensing elements within the electrodes may increase an interface between the electrodes and increase the accuracy of measurements and subsequent determinations made based on mutual capacitance measurements. For example, comparisons of mutual capacitance measurements with threshold values, as discussed in greater detail below with reference to FIG. 6 and FIG. 7, may be performed with greater accuracy when the geometry and spacing of electrodes and sensing elements is configured to increase an amplitude of a measured mutual capacitance thus increasing an amplitude of the signal being measured and analyzed.

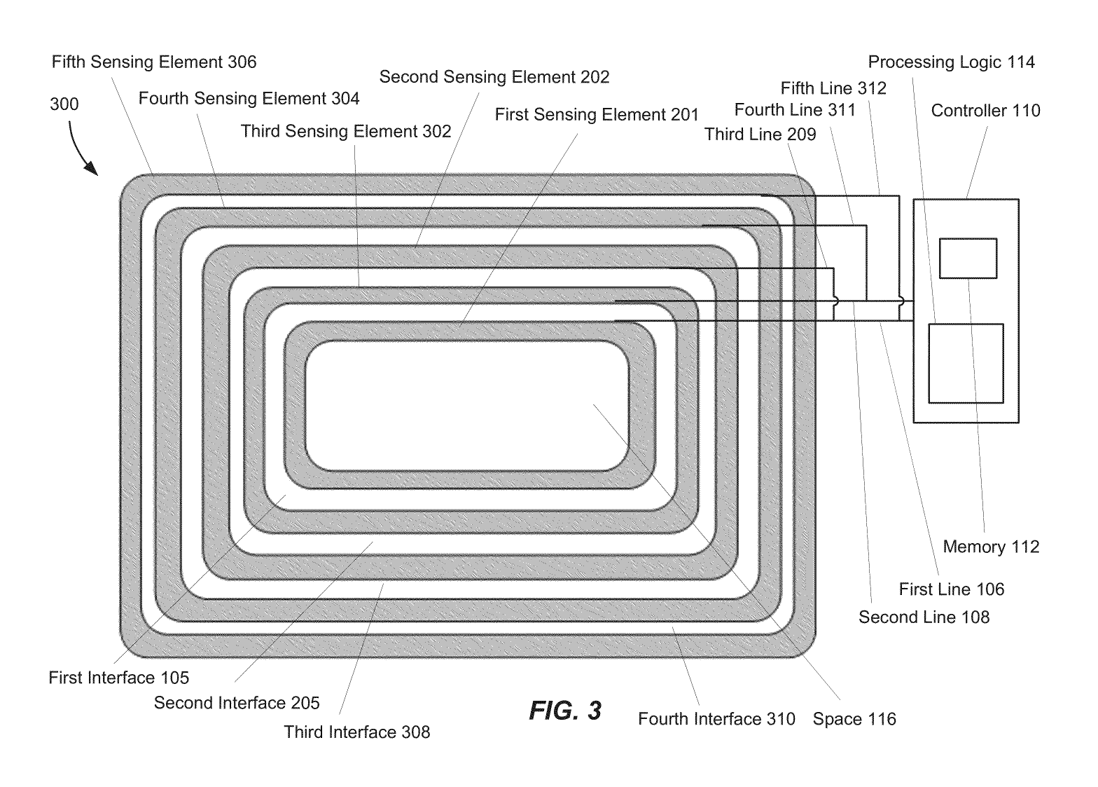

FIG. 3 illustrates a diagram of yet another example of a capacitive sensing device, implemented in accordance with some embodiments. As similarly discussed above, a capacitive sensing device, such as capacitive sensing device 300 described in greater detail below, may be implemented as a component of a device to enable the use of a capacitive sensing touchscreen or button by a user with a bare finger, gloved finger, and/or stylus or other configurations of conductive entities. As will be discussed in greater detail below, electrodes may be implemented using several sensing elements to increase an electromagnetic interface between electrodes, and further increase an accuracy of event determinations made based, at least in part, on mutual capacitance measurements. Accordingly, both a first electrode and a second electrode may include multiple sensing elements to increase the precision of mutual-capacitance based determinations.

As discussed above with reference to FIGS. 1 and 2, capacitive sensing device 200 may include second electrode 104, first interface 105, first line 106, second line 108, third line 209, controller 110, memory 112, processing logic 114, and space 116. As discussed above, the first electrode may include several sensing elements, such as first sensing element 201 and second sensing element 202. In various embodiments, the first electrode may include additional sensing elements, such as fifth sensing element 306. Moreover, the second electrode may include several sensing elements as well, such as third sensing element 302 and fourth sensing element 304. Furthermore, sensing elements for each respective electrode may be electrically coupled with each other, thus collectively functioning as a single electrode. For example, fifth sensing element 306 may be coupled with first line 106 via fifth line 312. Moreover, second sensing element may be coupled with first line 106 via third line 209. In this way, first sensing element 201, second sensing element 202, and fifth sensing element 306 may all be electrically coupled together as a first electrode which may be coupled with controller 110. Similarly, fourth sensing element 304 may be coupled with second line 108 via fourth line 311. Accordingly, third sensing element 302 and fourth sensing element 304 may be coupled with each other as a second electrode which may be coupled with controller 110. While various embodiments, disclosed herein describe various different lines, it will be appreciated that lines described as coupled together may also be implemented as a single line. For example, first line 106, third line 209 and fifth line 312 may all be implemented as a single conductive structure that is a line or bus coupling their associated sensing elements with each other and with controller 110.

Furthermore, as shown in FIG. 3 and similarly discussed above, the sensing elements may be implemented with similar geometries but varying dimensions. Accordingly, interfaces may exist between the sensing elements, such as first interface 105, second interface 205, third interface 308, and fourth interface 310. When the first electrode and second electrode are implemented in this way, an overall interface between the first electrode and the second electrode may be further increased and may further increase the accuracy of measurements and determinations made based, at least in part, on mutual capacitance measurements. While FIGS. 1-3 illustrate examples of capacitive sensing device having various configurations of electrodes and sensing elements, capacitive sensing devices as disclosed herein may have any suitable number of electrodes and sensing devices. Accordingly, capacitive sensing devices may be implemented with, for example, four electrodes, or electrodes having four sensing elements each. Moreover, other parameters of capacitive sensing devices disclosed herein may be configured to increase an accuracy of mutual capacitance dependent measurements disclosed herein. For example, for a particular stackup or assortment of materials included in a capacitive sensing device, the stackup may have designated thicknesses and permittivities determined based on an application or use of the capacitive sensing device. Moreover, the capacitive sensing device may be configured to operate with various different touch objects made of difference materials. Accordingly, a number of electrodes, a number of sensing elements included in each electrode, and a size of each respective interface may be configured based on the physical and electromagnetic properties of the materials and the touch object used with the capacitive sensing device.

FIG. 4 illustrates a diagram of another example of a capacitive sensing device, implemented in accordance with some embodiments. As similarly discussed above, a capacitive sensing device, such as capacitive sensing device 400, may be implemented as a component of a device to enable the use of a capacitive sensing touchscreen or button by a user with a bare finger, gloved finger, and/or stylus. As will be discussed in greater detail below, electrodes may be implemented with geometry features that further increase an accuracy of event determinations made based, at least in part, on mutual capacitance measurements. Accordingly, both a first electrode and a second electrode may include geometry features to increase the precision of mutual-capacitance based determinations.

As discussed above, capacitive sensing device 400 may include first electrode 102, second electrode 104, first interface 105, first line 106, second line 108, controller 110, memory 112, processing logic 114, and space 116. In various embodiments, one or more features of first electrode 102 and second electrode 104 may be modified or configured to further increase the accuracy of mutual capacitance measurements as may be specified by a mutual capacitance parameter which may represent a target amplitude of a mutual capacitance measurement that corresponds to a touch event associated with a conductive entity covered by an insulator, such as a glove touch event. For example, first electrode 102 may include first portion 402 which may be configured to increase a size of first interface 105, thus increasing a mutual capacitance between first electrode 102 and second electrode 104. For example, first portion 402 may include several surface features or geometry features which increase a length or surface area of an edge of first electrode 102. In one example, first portion 402 may include a sawtooth pattern or a triangular pattern that increases a linear distance of an outer edge of first electrode 102. Moreover, second electrode 104 may be configured to include second portion 404 that may be configured to include a pattern that is complementary to the pattern of first portion 402. In this way, an edge of second electrode 104 that faces first interface 105 may be configured to complement a geometry of the edge of first electrode 102 that also faces first interface 105. As discussed above, the geometry of the edges may greatly increase the size of first interface 105, and greatly increase the amplitude of signals underlying the identification of glove touch events. Accordingly, the geometry may increase the accuracy with which capacitive sensing device 400 may distinguish between different types of touch events and hover events.

While FIG. 4 illustrates one implementation of first portion 402 and second portion 404, other implementations are contemplated and disclosed herein. For example, first portion 402 and second portion 404 may extend all the way around first interface 105 such that the entire length of first interface 105 includes surface features. Moreover, such surface features may be implemented with other capacitive sensor configurations which include additional electrodes and additional sensing elements. Furthermore, a distance or size of an interface, such as first interface 105, may be configured to increase an accuracy of determinations made based on mutual capacitance measurements. For example, in a capacitive sensing device that includes several sensing elements per electrode, such as capacitive sensing device 300 discussed above with reference to FIG. 3, electrodes and sensing elements may be positioned at different distances from each other. In this example, different mutual capacitance measurements may be made for different electrodes at different distances from each other to obtain a mutual capacitance measurement that has a greater accuracy.

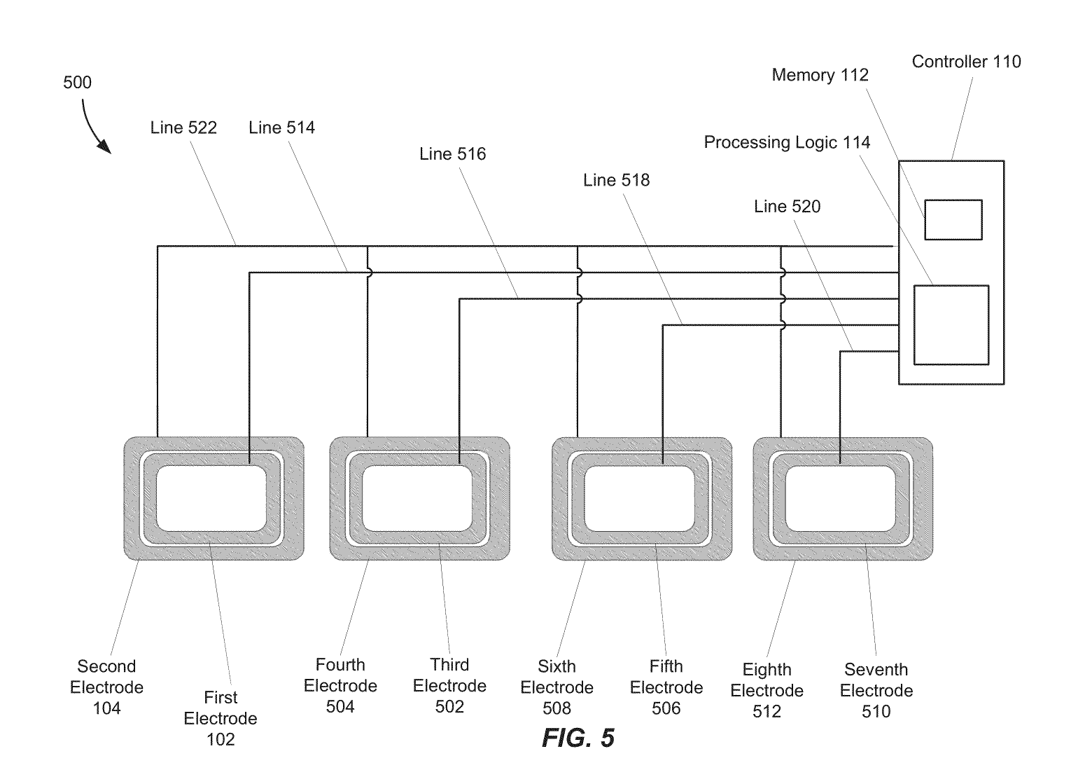

FIG. 5 illustrates a diagram of yet another example of a capacitive sensing device, implemented in accordance with some embodiments. As similarly discussed above, a capacitive sensing device, such as capacitive sensing device 500, may be implemented as a component of a device to enable the use of a capacitive sensing touchscreen or button by a user with a bare finger, gloved finger, and/or stylus or other configurations of conductive entities. In various embodiments, capacitive sensing device 500 may be further configured to detect and identify faults in sensing elements and electrodes implemented within capacitive sensing device 500. Such faults may result from a broken connection between a controller and any of the electrodes or sensing elements. Accordingly, as will be discussed in greater detail below, capacitive sensing device 500 may be configured to implement one or more fault detection operations to identify faulty capacitive sensors.

As discussed above, capacitive sensing device 500 may include first electrode 102, second electrode 104, first line 106, controller 110, memory 112, and processing logic 114. In various embodiments, while capacitive sensing device 500 may include first electrode 102 and second electrode 104 that may be implemented for a first button, capacitive sensing device 500 may further include other electrodes associated with other buttons or touchscreens. For example, capacitive sensing device 500 may include third electrode 502 and fourth electrode 504 which may be associated with a second button, fifth electrode 506 and sixth electrode 508 which may be associated with a third button, and seventh electrode 510 and eighth electrode 512 which may be associated with a fourth button. In one example, one electrode for each button may be coupled with controller 110 via its own line. For example, first electrode 102 may be coupled with controller 110 via line 514, third electrode 502 may be coupled with controller 110 via line 516, fifth electrode 506 may be coupled with controller 110 via line 518, and seventh electrode 510 may be coupled with controller 110 via line 520. Moreover, second electrode 104, fourth electrode 504, sixth electrode 508, and eighth electrode 512 may be coupled to controller 110 via a common line such as line 522.

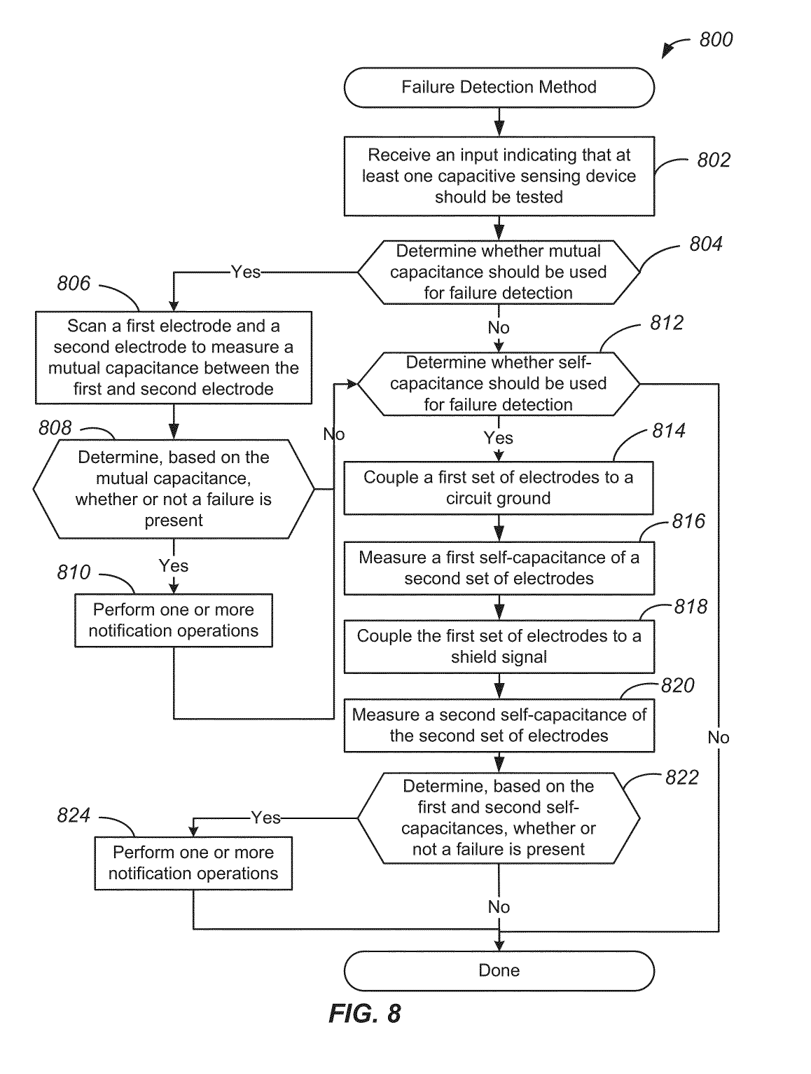

In various embodiments, capacitive sensing device 500 may be configured to identify faulty capacitive sensors based on one or more mutual capacitance measurements. Accordingly, a component, such as controller 110, may measure a mutual capacitance of a particular button, or may cycle through all attached buttons, to obtain at least one mutual capacitance measurement. As will be discussed in greater detail below with reference to FIG. 8, controller 110 may be configured to compare the measured mutual capacitance with a threshold mutual capacitance value. Such a threshold mutual capacitance value may have been previously determined by a hardware manufacturer such as Cypress Semiconductor of San Jose, Calif. In various embodiments, a break in a connection between controller 110 and either of the electrodes for which the mutual capacitance value is being measured will create an open circuit in the measurement path and result in an abnormally low measurement that will be below the threshold mutual capacitance value. Accordingly, if the measured mutual capacitance value is below the threshold, the controller may identify a fault or error and perform one or more operations in response to identifying the fault or error. For example, controller 110 may be configured to generate a message or set a flag that may notify another system component or a user of the device in which controller 110 is implemented.

Furthermore, capacitive sensing device 500 may be further configured to identify faulty capacitive sensors based on one or more self-capacitance measurements. As shown in FIG. 5, electrodes may be coupled to a common line, such as line 522, which may be coupled to controller 110. In various embodiments, these electrodes may also have their own independent lines through which they are coupled to controller 110, but the electrodes might be selectively coupled to line 522 when fault detection operations are performed. In various embodiments, the coupling of the electrodes to line 522 may be controlled by controller 110 via the operation of one or more switches. In various embodiments, controller 110 may be configured to acquire a first set of self-capacitances measurements from a first set of electrodes, which may include first electrode 102, third electrode 502, fifth electrode 506, and seventh electrode 510. Controller 110 may acquire the first set of self-capacitance measurements by coupling line 522 to a circuit ground and measuring self-capacitances of the first set of electrodes. Controller 110 may be further configured to couple line 522 to a shield signal and acquire a second set of self-capacitance measurements. Controller 110 may analyze a difference between the two sets of measurements to identify faulty capacitive sensors. If there is no or little difference between the sets of measurements for a particular button or touchscreen, then a fault may be identified and a broken connection inferred. For example, if a difference between the two measurements is below a threshold value for a particular button, controller 110 may identify the button, or one or more connections associated with the button, as faulty and perform one or more operations as described above.

While fault detection has been described above with reference to FIG. 5 which illustrates multiple buttons or touchscreens, such fault detection may be implemented with any of the above described embodiments which may include any number of buttons or touchscreens. For example, mutual capacitance based fault detection may be implemented with a single button as described above with reference some of the embodiments disclosed in FIG. 1.

FIG. 6 illustrates a flow chart of an example of a capacitive sensing method, implemented in accordance with some embodiments. As similarly discussed above, capacitive sensing devices and systems may be configured to identify various different user inputs received from a user that may be using various different conductive entities that may or may not be covered by an insulator. For example, the user may provide an input that is a finger touch, a glove touch, a stylus touch, and a hover. As disclosed herein, other touch events may also be identified, such as those associated with mechanical tools and components which may be conductive and may or may not be covered by an insulated layer. In various embodiments, various components of the capacitive sensing devices and systems disclosed herein may be implemented to analyze self-capacitances and mutual capacitances to accurately identify each particular type of user input. As will be discussed in greater detail below, measured self-capacitances and mutual capacitances may be analyzed sequentially and/or in combination to accurately distinguish between different types of touch events and different types of hover events.

Method 600 may commence with operation 602 during which a first self-capacitance of a first electrode may be measured. Accordingly, a component of a capacitive sensing or system, such as a controller, may scan a first electrode and measure a self-capacitance of the first electrode. As discussed above, the first electrode may be included in a touchscreen or may be implemented as part of a button assembly. In some embodiments, the first electrode may have a ring-like geometry and may be implemented as an inner electrode. Once the first self-capacitance has been measured, it may be stored in a memory for subsequent analysis.

Method 600 may proceed to operation 604 during which a second self-capacitance of a second electrode may be measured. As similarly discussed above, a component of the capacitive sensing or system, such as the controller, may scan a second electrode and measure a self-capacitance of the second electrode. Similar to above, the second electrode may be implemented in the same touchscreen or button assembly as the first electrode. Moreover, the second electrode may also have a ring-like geometry and may be implemented as an outer electrode that has a larger diameter than the first electrode. Once the second self-capacitance has been measured, it also may be stored in memory for subsequent analysis.

Method 600 may proceed to operation 606 during which a mutual capacitance between the first electrode and the second electrode may be measured. Accordingly, the controller may be configured to measure a mutual capacitance between the first electrode and the second electrode. Once the mutual capacitance has been measured, it may be stored in the memory for subsequent analysis.

Method 600 may proceed to operation 608 during which it may be determined whether or not a touch event or a hover event has occurred. In various embodiments, such a determination may be made based on a first self-capacitance measurement of the first electrode, a second self-capacitance measurement of the second electrode, and a mutual capacitance measurement of the first electrode and the second electrode. In various embodiments, operation 608 may include determining a touch value characterizing a presence or absence of a touch event may be determined. According to some embodiments, the touch event may be associated with a conductive entity that may be covered in an insulator. For example, the conductive entity may be a finger, and the insulator may be a glove. Accordingly, the touch value may be a glove touch value. In some embodiments, the conductive entity may be a mechanical tool or component such as a bit implemented in a mechanical drill. In various embodiments, the touch value may be one or more data values that are configured to indicate or identify that touch event has or has not occurred. Accordingly, the touch value may be a numerical string, a flag, or other identifier.

In various embodiments, the touch value may be determined based on the first self-capacitance, the second self-capacitance, and the mutual capacitance. Accordingly, as will be discussed in greater detail below with reference to FIG. 7, a component, such as the controller, may analyze each of the measured capacitances by, for example, selectively comparing them with designated threshold values, to determine what type of event has occurred, if any at all. Accordingly, the controller may determine, among other things, whether or not a touch event has occurred, and the controller may generate the touch value based on this determination. As will be discussed in greater detail below, the controller may also generate other values, such as additional touch values associated with different conductive entities and different configurations of conductive entities, as well as hover values.

FIG. 7 illustrates a flow chart of another example of a capacitive sensing method, implemented in accordance with some embodiments. As similarly discussed above, capacitive sensing devices and systems may be configured to identify and distinguish between various different types of touches and hovers. For example, embodiments disclosed herein may distinguish between finger touches, glove touches, stylus touches, touches generated by other mechanical entities, as well as hovers. In various embodiments, various components of the capacitive sensing devices and systems disclosed herein may be implemented to analyze self-capacitances and mutual capacitances as well as associated threshold values to accurately identify each particular type of user input. As will be discussed in greater detail below, the implementation of a capacitive sensing method, such as method 700, may be executed by a component, such as a controller and configuration data stored in memory.

Method 700 may commence with operation 702 during which a first electrode may be scanned to measure a first self-capacitance. As discussed above, the first electrode may be implemented as part of a button assembly or in a touchscreen of a device, such as a mobile communications device. For example, the first electrode may be an inner electrode of a capacitive sensor implemented in a button. In various embodiments, a system component, such as a controller, may scan the first electrode to measure a first self-capacitance of the first electrode. Such a self-capacitance measurement may be implemented based on designated parameters, such as a sensitivity gain, which may have been previously determined by a manufacturer, such as Cypress Semiconductor of San Jose, Calif.

Method 700 may proceed to operation 704 during which a second electrode may be scanned to measure a second self-capacitance. As discussed above, the second electrode may also be implemented as part of a button assembly or in a touchscreen of a device, such as a mobile communications device. For example, the second electrode may be an outer electrode of a capacitive sensor implemented in a button, and may be implemented adjacent to the first electrode, as discussed above with reference to FIGS. 1, 2, 3, and 4. In various embodiments, a system component, such as a controller, may scan the second electrode to measure a second self-capacitance of the second electrode. As similarly discussed above, the second self-capacitance measurement may be implemented based on designated parameters, such as a sensitivity gain, which may have been previously determined by a manufacturer, such as Cypress Semiconductor of San Jose, Calif.

Method 700 may proceed to operation 706 during which both the first electrode and the second electrode may be scanned to measure a third self-capacitance. In various embodiments, the controller may be configured to couple the first and second electrode together such that the first and second electrodes are operable as a single combined electrode. During operation 706, the controller may scan the combined electrode to measure a third self-capacitance. In various embodiments, as similarly discussed above, the third self-capacitance may be implemented based on designated parameters, such as a sensitivity gain, which may have been previously determined by a manufacturer, such as Cypress Semiconductor of San Jose, Calif. In one example, the sensitivity gain used to measure the third self-capacitance may be greater than then the sensitivity gains used to measure the first and second self-capacitances. Accordingly, the third self-capacitance may be measured as part of a proximity detection measurement.

Method 700 may proceed to operation 708 during which the first electrode and the second electrode may be scanned to measure a mutual capacitance. Accordingly, a system component, such as the controller may measure a mutual-capacitance between the first electrode and the second electrode. In various embodiments, if the first and second electrodes were previously coupled together to obtain the third self-capacitance measurement, then the first and second electrodes may be de-coupled from each other prior to mutual capacitance measurement, and the mutual capacitance measurement may subsequently be obtained by the controller scanning the first and second electrodes. Furthermore, in some embodiments, the controller may be implemented, at least in part, in a re-programmable logic block. Thus, processing logic included in the controller may be reconfigured from a first configuration to a second configuration. The first configuration may be configured to obtain self-capacitance measurements as discussed above with reference to operations 702, 704, and 706. However, the second configuration may be configured to obtain mutual-capacitance measurements as may occur during operation 708. Configuration data for each configuration may be stored in a memory which may be included in the controller. Moreover, the configuration data may be accessed and implemented based on firmware also stored in the memory. In this way, the controller may be dynamically reconfigured to implement different scanning modalities, such as self-capacitance or mutual capacitance, during method 700.

Method 700 may proceed to operation 710 during which it may be determined whether or not a first touch event has occurred. As will be discussed in greater detail below, such a determination may be made based on a comparison of the self-capacitance measurements with a first set of threshold values. In some embodiments, operation 710 includes determining whether or not a first touch value identifying a first touch event should be generated. In various embodiments, such a determination may be made based on the first self-capacitance and the second self-capacitance. In various embodiments, the controller may analyze the first self-capacitance measurement, the second self-capacitance measurement, and a first set of threshold values to determine the first touch value associated with a first conductive entity. In some embodiments, the first conductive entity may be a finger of a user. Accordingly, the first touch value may be a finger touch value which may include one or more data values configured to identify whether or not a finger touch event has occurred. For example, the finger touch value may be a flag, a Boolean indicator, or any other suitable data value. A component, such as a controller, may be configured to determine the finger touch value based on a comparison of the first self-capacitance measurement and the second self-capacitance measurement with a first finger touch threshold value and a second finger touch threshold value. The first and second finger touch threshold values, as well as any of the threshold values discussed in greater detail below, may have been previously determined by a manufacturer, such as Cypress Semiconductor of San Jose, Calif., based on performance data associated with devices that may be used to implement method 700.

In various embodiments, if both the first self-capacitance measurement and the second self-capacitance measurement exceed the first finger touch threshold value and the second finger touch threshold value respectively, then the controller may identify that a finger touch event has occurred, and may determine and generate a finger touch value that indicates that a finger touch event has occurred. However, if either of the first self-capacitance measurement or the second self-capacitance measurement do not exceed the first finger touch threshold value and the second finger touch threshold value respectively, then the controller may identify that a finger touch event has not occurred, and may determine and generate a finger touch value that indicates that a finger touch event has not occurred. As disclosed herein, the first conductive entity may also be a portion of a mechanical tool or other conductive entity capable of being used with a capacitive sensor. In such embodiments, each conductive entity may be implemented with its own corresponding set of threshold values, as similarly discussed above, which may have been determined and configured by a manufacturer such as Cypress Semiconductor of San Jose, Calif. Accordingly, if the controller determines that a first touch event has occurred, method 700 may proceed to operation 717 discussed in greater detail below. However, if the controller determines that no first touch event has occurred, method 700 may proceed to operation 712.

Accordingly, method 700 may proceed to operation 712 during which it may be determined whether or not a second touch event has occurred. As will be discussed in greater detail below, such a determination may be made based on a comparison of the self-capacitance measurements with a second set of threshold values. In some embodiments, operation 712 includes determining whether or not a second touch value identifying a second touch event should be generated. In various embodiments, such a determination may be made based on the first self-capacitance and the second self-capacitance. Accordingly, a component, such as the controller, may analyze the first self-capacitance measurement, the second self-capacitance measurement, and a second set of threshold values to determine the second touch value which may be a stylus touch value associated with a stylus touch event. In various embodiments, the second set of threshold values may be different than the first set of threshold values, and may be configured to identify a particular type of touch event, such as a stylus touch event. Thus, the first self-capacitance measurement and the second self-capacitance measurement may be compared to a first stylus touch threshold value and a second stylus touch threshold value to determine whether or not a stylus touch event has occurred. In some embodiments, the stylus touch threshold values are different than the finger touch threshold values. As discussed above and in greater detail below, some threshold values, such as the first finger touch threshold value and the first stylus touch threshold value, may be associated with a first electrode while other threshold values, such as the second finger touch threshold value and the second stylus touch threshold value, may be associated with a second electrode. As will be discussed in greater detail below, values of the threshold values may be configured to identify different types of events.

In various embodiments, the first and second electrodes may be implemented in a capacitive sensor of a button assembly, as previously discussed. Accordingly, self-capacitance measurements associated with each electrode may vary based on type of object that is contacting the capacitive sensor. For example, a finger may be larger than a stylus and may induce a large self-capacitance measurement across both the first and second electrodes due to the relatively large surface area of the finger that may extend over the first and second electrodes when contacting the capacitive sensor. In some embodiments, a stylus may be smaller than the finger and may induce a large self-capacitance measurement in the first electrode, which may be nearest to the center of the button where contact may be occurring. However, the stylus might not induce a large self-capacitance measurement in the second electrode because the end of the stylus might not be large enough to extend to the second electrode. Accordingly, the second stylus touch threshold value may be configured to be less than the second finger touch threshold value. In this way, the threshold values may be configured distinguish between finger touches and stylus touches.

Accordingly, if both the first self-capacitance measurement and the second self-capacitance measurement exceed the first stylus touch threshold value and the second stylus touch threshold value respectively, then the controller may identify that a stylus touch event has occurred, and may determine and generate a stylus touch value that indicates that a stylus touch event has occurred. However, if either of the first self-capacitance measurement or the second self-capacitance measurement do not exceed the first stylus touch threshold value and the second stylus touch threshold value respectively, then the controller may identify that a stylus touch event has not occurred, and may determine and generate a stylus touch value that indicates that a stylus touch event has not occurred.

In some embodiments, the controller may be further configured to analyze a variance between the first self-capacitance measurement and the second self-capacitance measurement. As discussed above, a size or geometry of the end of the stylus that may contact the capacitive sensor may cause a difference between the first self-capacitance measurement and the second self-capacitance measurement. In some embodiments, the controller may be configured to calculate a first difference value that identifies a difference between the first and second self-capacitances. The controller may be configured to compare the first difference value with a third stylus touch threshold value. Accordingly, the determination of the stylus touch value may be further determined based on whether or not the first difference value is greater than a third stylus touch threshold value.

In some embodiments, the second touch value, as well as the first touch value, may be configured to differentiate between different sizes of conductive entities or different combinations of conductive entities. For example, if the conductive entity is a finger, the first touch value and a first set of threshold values may be configured to identify a presence or absence of a combination of fingers and/or a large finger. In this example, the second touch value and a second set of threshold values may be configured to identify the presence or absence of a single finger and/or a smaller finger. In this way, the first touch value and the second touch value may be configured to distinguish between different types of conductive entities, such as fingers and styluses, as well as different sizes or combinations of the same type of conductive entity, such as different sizes or combinations of fingers.

As discussed above, operation 712 may be performed optionally and in response to a determination made during operation 710. For example, if during operation 710, the controller determines that a first touch event has occurred, operation 712 might not be performed, and method 700 might instead proceed to operation 717. However, if the controller determines that a first touch event has not occurred, operation 712 is performed and a second touch value may be determined. Thus, according to some embodiments, operation 712 may be performed in response to identifying that first touch event has not occurred and/or determining a first touch value that identifies that a first touch event has not occurred. Accordingly, if the controller determines that a second touch event has occurred, method 700 may proceed to operation 717. However, if the controller determines that no second touch event has occurred, method 700 may proceed to operation 714.

Accordingly, method 700 may proceed to operation 714 during which it may be determined whether or not a third touch event has occurred. As will be discussed in greater detail below, such a determination may be made based on a comparison of the mutual capacitance measurement with a third set of threshold values. In some embodiments, operation 710 includes determining whether or not a third touch value identifying a third touch event should be generated. In various embodiments, such a determination may be made based, at least in part, on the mutual capacitance. Accordingly, a component, such as the controller, may analyze the mutual capacitance measurement and may determine the third touch value which may be a glove touch value associated with a glove touch event. Thus, the mutual capacitance measurement may be compared to a glove touch threshold value to determine whether or not a glove touch event has occurred. Accordingly, if the mutual capacitance measurement exceeds the glove touch threshold value, then the controller may identify that a glove touch event has occurred, and may determine and generate a glove touch value that indicates that a glove touch event has occurred. However, if the mutual capacitance measurement does not exceed the glove touch threshold value, then the controller may identify that a glove touch event has not occurred, and may determine and generate a glove touch value that indicates that a glove touch event has not occurred.

While the above-described embodiments describe a glove touch event associated with a gloved finger, the third touch value and a third set of threshold values may also correspond to other conductive entities such as mechanical tools, portions of tools, end effectors of robotic arms, which may be covered with an insulator, such as a rubber or polymer. As similarly discussed above, appropriate threshold values may have been previously determined for each type of conductive entity by a manufacturer, such as Cypress Semiconductor of San Jose, Calif.

As similarly discussed above, operation 714 may be performed responsive to the controller determining, during operation 712, that a second touch event has not occurred. In this way, the identification of the third touch event and the determination of a third touch value may be responsive to determining that a first touch event has not occurred and a second touch event has not occurred, as may have been determined based on the previously described comparisons of self-capacitance measurements with various threshold values. In an example in which a glove touch is occurring, both of the possibilities of a finger touch and stylus touch would have been eliminated by the previous determinations made during operation 710 and operation 712. Accordingly, during operation 714, the controller may accurately identify a glove touch event and may generate a corresponding glove touch value.

While operation 714 is described as using mutual capacitance measurements, in some embodiments, operation 714 may implement self-capacitance measurements to make a determination. According to various embodiments, a system component, such as a controller, may be configured to analyze a difference between the self-capacitance measurements and generate a third touch value based on the result of the analysis. For example, the controller may calculate a difference between the first self-capacitance and the second self-capacitance. If the difference is less than a self-capacitance third touch threshold value, a third touch event may be identified as having occurred. If the difference between the first self-capacitance and the second self-capacitance is greater than the self-capacitance third touch threshold value, a third touch event may be identified as not having occurred. In various embodiments, if a component, such as the controller, determines that a third touch event has occurred, method 700 may proceed to operation 717. However, if the controller determines that no third touch event has occurred, method 700 may proceed to operation 716.

Accordingly, method 700 may proceed to operation 716 during which it may be determined whether or not a hover event has occurred. As will be discussed in greater detail below, such a determination may be made based on a comparison of the third self-capacitance measurement with another threshold value. In some embodiments, operation 716 includes determining whether or not a hover value identifying a hover event should be generated. In various embodiments, such a determination may be made based on the third self-capacitance. Accordingly, a component, such as the controller, may analyze the third self-capacitance measurement and may determine a hover value. Thus, the third self-capacitance measurement may be compared to a hover threshold value to determine whether or not a hover event has occurred. Accordingly, if the third self-capacitance measurement exceeds the hover threshold value, then the controller may identify that a hover event has occurred, and may determine and generate a hover value that indicates that a hover event has occurred. However, if the third self-capacitance measurement does not exceed the hover threshold value, then the controller may identify that a hover event has not occurred, and may determine and generate a hover value that indicates that a hover event has not occurred. As similarly discussed above, the hover event may be generated by the presence of a conductive entity, such as a finger, a combination of fingers, or a mechanical entity, such as a tool or portion of a tool.

Moreover, operation 716 may be performed responsive to the controller determining, during operation 714, that a third touch event has not occurred. In this way, the identification of a hover event and the determination of a hover value may be responsive to determining that a first touch event has not occurred, a second touch event has not occurred, and a third touch event has not occurred, as may have been determined based on the previously described comparisons of self-capacitance measurements and mutual capacitance measurements with various threshold values. In an example in which a finger or glove hover event is occurring, the possibilities of a finger touch, stylus touch, and glove touch would have been eliminated by the previous determinations made during operation 710, operation 712, and operation 714. Accordingly, during operation 716, the controller may accurately identify a hover event and may generate a corresponding hover value. Furthermore, a hover value indicating that no hover event has occurred may also be stored as a general indicator that is configured to indicate that no event has occurred. In some embodiments, the general indicator may accurately indicate that no finger touch event has occurred, no stylus touch event has occurred, no glove touch event has occurred, and no hover event has occurred. In various embodiments, if a component, such as the controller, determines that a hover event has occurred, method 700 may proceed to operation 717. However, if the controller determines that no hover event has occurred, method 700 may proceed to operation 718.

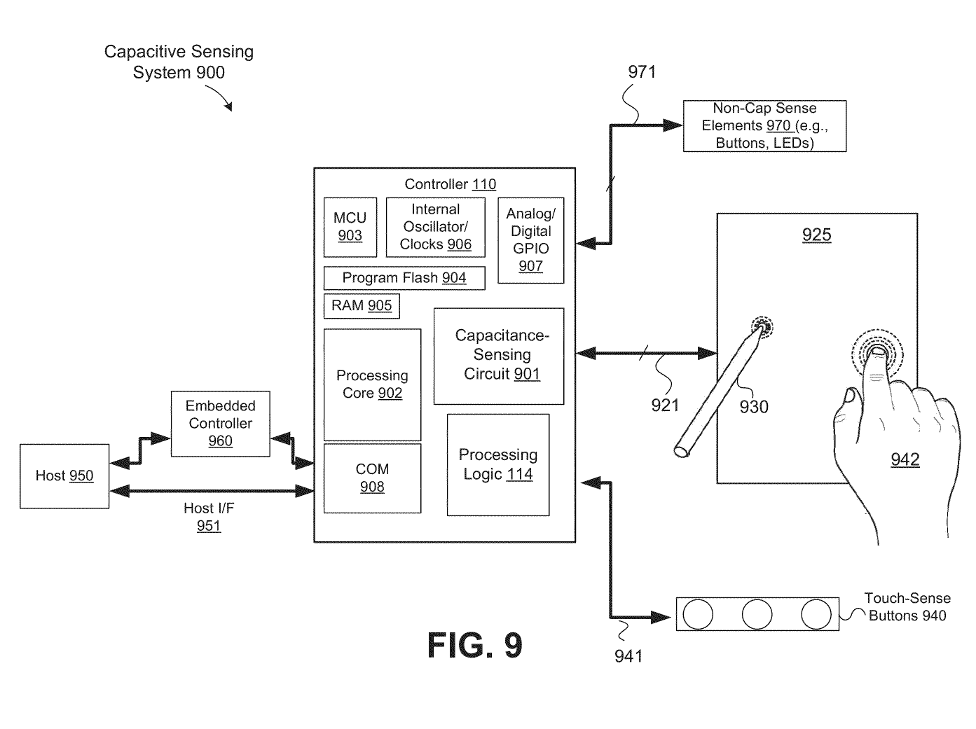

Method 700 may proceed to operation 717 during which an event may be reported. As discussed above with reference to operations 710, 712, 714, and 716, a component, such as a controller, may identify the occurrence of one or more various different types of touch and hover events. In response to the controller identifying the occurrence of an event, the event may be reported to another component or device. For example, as will be discussed in greater detail below with reference to FIG. 9, a system in which the controller is implemented may include a host device. In some embodiments, the occurrence of the event may be reported to the host device. The event may be reported in a message sent via one or more buses. In this way, other components of devices and/or systems in which the controller is implemented may be notified of the occurrence and detection of an event which may be a touch event or a hover event, as discussed above.

Method 700 may proceed to operation 718 during which it may be determined whether or not additional scans should be performed. Such a determination may be made based on one or more designated parameters, such as the passage of a designated period of time. Accordingly, method 700 may be repeated periodically as part of a periodic scanning and detection process. In some embodiments, method 700 may be repeated dynamically in response to a system event. If it is determined that additional scans should be performed, method 700 may return to operation 702. If it is determined that no additional scans should be performed, method 700 may terminate.

In various embodiments, the order in which the previously described operations are performed may be varied. For example, scanning operations may be interleaved with corresponding determinations of values. In one example, operations 702 and 704 may be performed, followed by operations 710 and 712, which may be followed by operation 708, 714, 706, and then 716. In this way, scans of electrodes may be performed before each determination of whether or not an event has occurred. In various embodiments, the controller may be configured to implement method 700 in this way to reduce power consumed by scans of electrodes which might not be utilized by subsequent determinations. Alternatively, the controller may be configured to implement scanning operations first and determinations performed based on the scans may be performed afterwards. When implemented in this way, separate accesses to processing logic performing calculations underlying the determinations of the values may be reduce and processing overhead may be reduced accordingly.

FIG. 8 illustrates a flow chart of an example of a failure detection method, implemented in accordance with some embodiments. In various embodiments, a failure detection method, such as method 800, may be implemented to identify failures and or errors that may occur in hardware components of a capacitive sensing device. For example, a failure or error may include a break in a connection between an electrode and a controller. Failure detection methods as disclosed herein may also be configured to generate a message that identifies the presence of such a failure. In this way, a capacitive sensing device may be configured to periodically and/or dynamically check for errors and hardware failures to ensure the proper operation of the capacitive sensing device.

Method 800 may commence with operation 802 during which an input may be received that indicates that at least one capacitive sensing device should be tested. As discussed above, a capacitive sensing device may be implemented in a button or a touchscreen. In various embodiments, a device, such as a mobile communications device or a household appliance, may include several capacitive sensing devices which may be implemented in several components of the device, such as buttons. In some embodiments, the input may be received at a component, such as a controller, and may be received from a user. For example, in a household appliance, such as a washer or dryer, a user may provide an input requesting an operation, such as the beginning of a washing or drying cycle. Accordingly, method 800 may be implemented dynamically and in response to receiving the input from the user. In various embodiments, the input may be received from another component, such as a timer or chronometer which may be configured to periodically generate the input in response to the passing of a designated period of time. Moreover, the input may be received upon startup of the device. Thus, method 800 may be implemented upon bootup of the device. Accordingly, method 800 may be implemented periodically and in response to receiving the input from another component.

Method 800 may proceed to operation 804 during which it may be determined whether mutual capacitance measurements should be used for failure detection. Such a determination may be made based on one or more measurement parameters which may be determined by a manufacturer. For example, if one electrode is included in the capacitive sensing device, self-capacitance measurements may be used and identified by a measurement parameter specified by a manufacturer. In another example, if multiple electrodes are included in the capacitive sensing device, mutual capacitance measurements may be used and identified by the measurement parameter. If it is determined that mutual capacitance measurements should be used for failure detection, then method 800 may proceed to operation 806. If it is determined that mutual capacitance measurements should not be used for failure detection, then method 800 may proceed to 812.

Accordingly, if it is determined that mutual capacitance measurements should be used for failure detection, method 800 may proceed to operation 806 during which a first electrode and a second electrode may be scanned to measure a mutual capacitance between the first and second electrodes. As discussed above, a component, such as a controller, may scan the electrodes and measure a mutual capacitance between them. The measurement may be stored in a memory which may be included in the controller or may be implemented externally. As discussed above, the device being tested may include several capacitive sensors. Accordingly, a mutual capacitance measurement may be made for each capacitive sensor implemented in the device being tested.

Method 800 may proceed to operation 808 during which it may be determined whether or not a failure is present. Such a determination may be made based on a comparison of the mutual capacitance measurements made during operation 806 and one or more first failure detection threshold values. For example, if a mutual capacitance measurement is below a failure detection threshold value, it may be inferred that a connection with either the first electrode or the second electrode has failed. However, if a mutual capacitance measurement is above a failure detection threshold value, it may be inferred that connections with the first electrode and the second electrode have not failed. In various embodiments, the failure detection threshold value may have been previously determined by as manufacturer, such as Cypress Semiconductor of San Jose, Calif. If it is determined that a failure is present, then method 800 may proceed to operation 810. If it is determined that a failure is not present, then method 800 may proceed to operation 812.

Accordingly, if it is determined that a failure is present, method 800 may proceed to operation 810 during which one or more notification operations may be performed. In various embodiments, notification operations may include generating a message, setting a flag, and/or generating an interrupt signal. For example, the controller may generate a message capable of being displayed in a graphical user interface that may be presented to a user. The message may include a string of text indicating that a hardware failure has occurred.

Method 800 may proceed to operation 812 during which it may be determined whether self-capacitance measurements should be used for failure detection. Such a determination may be made based on a measurement parameter, as discussed above. If it is determined that self-capacitance measurements should be used for failure detection, then method 800 may proceed to operation 814. If it is determined that self-capacitance measurements should not be used for failure detection, then method 800 may terminate.

Accordingly, if it is determined that self-capacitance measurements should be used for failure detection, method 800 may proceed to operation 814 during which a first set of electrodes may be coupled to a circuit ground. In various embodiments, a component, such as a controller, may be configured to couple the first set of electrodes to a circuit ground. The first set of electrodes may include a first electrode of the capacitive sensor being tested. Where multiple capacitive sensors are being tested, the first set of electrodes may include corresponding electrodes from each capacitive sensor. For example, as discussed above with reference to FIG. 5, each capacitive sensor being tested may be a button that includes a first electrode that is an inner electrode and a second electrode that is an outer electrode. In this example, the first set of electrodes may include the inner electrodes and a second set of electrodes may include the outer electrodes. In some embodiments, if there a single capacitive sensor being tested, the first set of electrodes and the second set of electrodes may include a single electrode each. Accordingly, during operation 814, all of the electrodes included in the first set of electrodes may be coupled to a circuit ground.

Method 800 may proceed to operation 816 during which a first self-capacitance of a second set of electrodes may be measured. Accordingly, the controller may scan a second set of electrodes to measure self-capacitances for each of the second set of electrodes to obtain a first set of self-capacitance measurements. As discussed above, during the scanning of the second set of electrodes, the first set of electrodes is coupled to a circuit ground.

Method 800 may proceed to operation 818 during which the first set of electrodes may be coupled to a shield signal. Accordingly, the controller may couple the first set of electrodes to a shield signal, and each electrode of the first set of electrodes may be driven by the shield signal. In various embodiments, the shield signal may be configured to reduce parasitic capacitances among electrodes during a subsequent scan of the electrodes. In various embodiments, the shield signal applied to the first set of electrodes may have a same or similar amplitude and polarity across the first set of electrodes.

Method 800 may proceed to operation 820 during which a second self-capacitance of the second set of electrodes may be measured. As similarly discussed above, the controller may scan the second set of electrodes to measure self-capacitances for each of the second set of electrodes to obtain a second set of self-capacitance measurements. As discussed above, during the scanning of the second set of electrodes, the first set of electrodes is driven by the shield signal.

Method 800 may proceed to operation 822 during which it may be determined, based on the first and second self-capacitances, whether or not a failure is present. Such a determination may be made based on a comparison between the first set of self-capacitance measurements and the second set of self-capacitance measurements. For example, a difference value may be calculated for each pair of measurements included in the first and second set of self-capacitance measurements and associated with a single electrode. In this way, two measured self-capacitances of an electrode implemented in a capacitive sensor may be obtained when another electrode in the same capacitive sensor is coupled to ground and is coupled to a shield signal, and may subsequently be used to calculate a difference value for the capacitive sensor that includes the electrode. If a calculated difference value is less than a second failure detection threshold value, a failure may be identified as being present because the coupling configuration of the first set of electrodes had little to no effect on the measurements as may be the case when a hardware failure is present. If the calculated difference value is greater than the second failure detection threshold value, a failure might be identified as not being present. Such a calculation may be performed for each capacitive sensor being tested. Accordingly, if it is determined that a failure is present, then method 800 may proceed to operation 824. If it is determined that a failure is not present, then method 800 may terminate.

Accordingly, if it is determined that a failure is present, method 800 may proceed to operation 824 during which one or more notification operations may be performed. As similarly discussed above, notification operations may include generating a message, setting a flag, and/or generating an interrupt signal. Accordingly, the controller may generate a message capable of being displayed in a graphical user interface that may be presented to a user. The message may include a string of text indicating that a hardware failure has occurred.

FIG. 9 illustrates a diagram of an example of a capacitive sensing system, implemented in accordance with some embodiments. As similarly discussed above, a capacitive sensing system 900 may include controller 110 for detecting a presence of a conductive object on a capacitive sense array 925 according to various embodiments. Capacitive sensing system 900 includes controller 110, capacitive sense array 925, touch-sense buttons 940, host processor 950, embedded controller 960, and non-capacitance sense elements 970. Controller 110 may include analog and/or digital general purpose input/output (“GPIO”) ports 907. GPIO ports 907 may be programmable. GPIO ports 907 may be coupled to a Programmable Interconnect and Logic (“PIL”), which acts as an interconnect between GPIO ports 907 and a digital block array of controller 110 (not shown). The digital block array may be configured to implement a variety of digital logic circuits (e.g., DACs, digital filters, or digital control systems) using, in one embodiment, configurable user modules (“UMs”). The digital block array may be coupled to a system bus. Controller 110 may also include memory, such as random access memory (“RAM”) 905 and program flash 904. RAM 905 may be static RAM (“SRAM”), and program flash 904 may be a non-volatile storage, which may be used to store firmware (e.g., control algorithms executable by processing core 902 to implement operations described herein). Controller 110 may also include a microcontroller unit (“MCU”) 903 coupled to memory and the processing core 902.

Controller 110 may also include an analog block array (not shown). The analog block array is also coupled to the system bus. Analog block array also may be configured to implement a variety of analog circuits (e.g., ADCs or analog filters) using, in one embodiment, configurable UMs. The analog block array may also be coupled to the GPIO ports 907.

As illustrated, capacitance sensor 901 may be integrated into controller 110. Capacitance sensor 901 may include analog I/O for coupling to an external component, such as capacitive sense array 925, touch-sense buttons 940, and/or other devices. Capacitance sensor 901 and controller 110 are described in more detail below.

Furthermore, controller 110 may include processing logic 114. As discussed above, processing logic 114 may be configured to make one or more determinations based on the previously described measurements. As previously discussed, controller 110 may be included in a device such as a mobile communications device or other device that received inputs from a user that may be using a bare finger, a gloved finger, or a stylus such as a passive stylus. Such inputs may be tactile inputs identified as touch events which may occur when the finger or stylus is touching the touchscreen or button. Such inputs may also be hover inputs identified as hover events which may occur when the finger or stylus is close to, but not touching, a touchscreen or button. The touch events and hover events may also be generated by inputs received from other conductive entities such as mechanical tools and end effectors which may or may not be covered in insulators. Accordingly, based on measurements obtained from signals received from first electrode 102 and second electrode 104 discussed above, processing logic 114 may be configured to determine various values, which may be data values, that characterize whether or not a particular touch or hover event has occurred. Accordingly, controller 110 as well as processing logic 114 may be configured to accurately distinguish between touch events generated by a bare conductive entity, touch events generated by a conductive entity covered in an insulator, and hover events generated by any conductive entity. In this way, embodiments disclosed herein enable a user to effectively use a glove finger as well as other instrument, such as a stylus with a capacitive sensor device. As previously discussed, processing logic 114 may be configured to determine a first touch value, a second touch value, a third touch value, and a hover value based on various different sets of threshold values as well as measurements.

Accordingly, various embodiments disclosed herein may be used in any capacitive sense array application, for example, the capacitive sense array 925 may be a touch screen, a touch-sense slider, or touch-sense buttons 940 (e.g., capacitance sense buttons). As discussed above, these sense devices may include one or more electrodes and capacitive sensing elements. The operations described herein may include, but are not limited to, notebook pointer operations, lighting control (dimmer), volume control, graphic equalizer control, speed control, or other control operations requiring gradual or discrete adjustments. It should also be noted that these embodiments of capacitive sense implementations may be used in conjunction with non-capacitive sense elements 970, including but not limited to pick buttons, sliders (ex. display brightness and contrast), scroll-wheels, multi-media control (ex. volume, track advance, etc) handwriting recognition and numeric keypad operation.

In one embodiment, the capacitive sensing system 900 includes a capacitive sense array 925 coupled to controller 110 via bus 921. The capacitive sense array 925 may include a one-dimensional sense array in one embodiment and a two dimensional sense array in another embodiment. Alternatively, the capacitive sense array 925 may have more dimensions. Also, in one embodiment, the capacitive sense array 925 may be sliders, touchpads, touch screens or other sensing devices. In another embodiment, the capacitive sensing system 900 includes touch-sense buttons 940 coupled to controller 110 via bus 941. Accordingly, controller 110 may be operable as a button controller. Touch-sense buttons 940 may include a single-dimension or multi-dimension sense array. As discussed above, the single- or multi-dimension sense array may include multiple electrodes and sensing elements.

The capacitive sensing system 900 may include any combination of one or more of the capacitive sense array 925, and/or touch-sense button 940. In another embodiment, the capacitive sensing system 900 may also include non-capacitance sense elements 970 coupled to controller 110 via bus 971. The non-capacitance sense elements 970 may include buttons, light emitting diodes (“LEDs”), and other user interface devices, such as a mouse, a keyboard, or other functional keys that do not require capacitance sensing. In one embodiment, buses 971, 941, and 921 may be a single bus. Alternatively, these buses may be configured into any combination of one or more separate buses.

Controller 110 may include oscillator/clocks block 906 and communication block (“COM”) 908. The oscillator/clocks block 906 provides clock signals to one or more of the components of controller 110. Communication block 908 may be used to communicate with an external component, such as a host processor 950, via host interface (“I/F”) line 951. Alternatively, controller 110 may also be coupled to the embedded controller 960 to communicate with the external components, such as host processor 950. In one embodiment, controller 110 is configured to communicate with the embedded controller 960 or the host processor 950 to send and/or receive data.

Controller 110 may reside on a common carrier substrate such as, for example, an integrated circuit (“IC”) die substrate, a multi-chip module substrate, or the like. Alternatively, the components of controller 110 may be one or more separate integrated circuits and/or discrete components. In one exemplary embodiment, controller 110 may be the Programmable System on a Chip (“PSoC®”) processing device, developed by Cypress Semiconductor Corporation, San Jose, Calif. Alternatively, controller 110 may be one or more other processing devices, such as a microprocessor or central processing unit, special-purpose processor, digital signal processor (“DSP”), an application specific integrated circuit (“ASIC”), a field programmable gate array (“FPGA”), or the like.

It should also be noted that the embodiments described herein are not limited to having a configuration of a processing device coupled to a host, but may include a system that measures the capacitance on the sense device and sends the raw data to a host computer where it is analyzed by an application. In effect the processing that is done by controller 110 may also be done in the host.

As discussed above, controller 110 of FIG. 9 may measure capacitance using various techniques, such as self-capacitance sensing and mutual capacitance sensing. Accordingly, controller 110 may detect conductive objects, such as touch objects 942 (fingers or passive styluses), an active or passive stylus 930, or any combination thereof. As discussed above, for a self-capacitance sensing mode, touching the sensor increases the sensor capacitance as added by the finger touch capacitance is added to the sensor capacitance. A mutual capacitance change may be detected in the mutual capacitance-sensing mode. In some embodiments, each sensor element uses at least two electrodes: one is a transmitter (TX) electrode (also referred to herein as transmitter electrode) and the other is a receiver (RX) electrode. When a finger touches a sensor or is in close proximity to the sensor, the capacitive coupling between the receiver and the transmitter of the sensor element is decreased as the finger shunts part of the electric field to ground (e.g., chassis or earth).

Capacitance sensor 901 may be integrated into the IC of controller 110, or alternatively, in a separate IC. The capacitance sensor 901 may include relaxation oscillator (RO) circuitry, a sigma delta modulator (also referred to as CSD) circuitry, charge transfer circuitry, charge accumulation circuitry, or the like, for measuring capacitance as would be appreciated by one of ordinary skill in the art having the benefit of this disclosure. Alternatively, descriptions of capacitance sensor 901 may be generated and compiled for incorporation into other integrated circuits. For example, behavioral level code describing capacitance sensor 901, or portions thereof, may be generated using a hardware descriptive language, such as VHDL or Verilog, and stored to a machine-accessible medium (e.g., CD-ROM, hard disk, floppy disk, etc.). Furthermore, the behavioral level code can be compiled into register transfer level (“RTL”) code, a netlist, or even a circuit layout and stored to a machine-accessible medium. The behavioral level code, the RTL code, the netlist, and the circuit layout all represent various levels of abstraction to describe capacitance sensor 901.

It should be noted that the components of capacitive sensing system 900 may include all the components described above. Alternatively, capacitive sensing system 900 may include only some of the components described above.

In one embodiment, capacitive sensing system 900 is used in a notebook computer. Alternatively, the capacitive sensing system 900 may be used in other applications, such as a mobile handset, a personal data assistant (“PDA”), a keyboard, a television, a remote control, a monitor, a handheld multi-media device, a handheld video player, a handheld gaming device, or a control panel.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A device comprising:
a first electrode implemented in a capacitive sensor;
a second electrode implemented in the capacitive sensor; and
a controller coupled to the first electrode and the second electrode, the controller being configured to:
determine whether a touch event or a hover event has occurred based on a first self-capacitance measurement of the first electrode, a second self-capacitance measurement of the second electrode, and a mutual capacitance measurement of the first electrode and the second electrode,
wherein the determination whether the hover event has occurred is responsive to a determination that a finger touch event, a stylus touch event, and a glove touch event have not occurred.

2. The device of claim 1, wherein the controller is further configured to determine whether the touch event or the hover event has occurred based on a comparison of the mutual capacitance measurement with a glove touch threshold value, wherein the touch event is a glove touch event, and
wherein the controller is further configured to determine whether the touch event or the hover event has occurred in response to determining that a finger touch event has not occurred, and in response to determining that a stylus touch event has not occurred.

3. The device of claim 2, wherein the controller is further configured to:
determine whether a finger touch event has occurred based on a comparison of the first self-capacitance measurement with a first finger touch threshold value and a comparison of the second self-capacitance measurement with a second finger touch threshold value;
determine whether a stylus touch event has occurred based on a comparison of the first self-capacitance measurement with a first stylus touch threshold value and a comparison of the second self-capacitance measurement with a second stylus touch threshold value, wherein the second stylus touch threshold value is less than the second finger touch threshold value; and
determine whether the hover event has occurred based on a comparison of a third self-capacitance measurement with a hover threshold value, the third self-capacitance measurement being a measured self-capacitance of a combination of the first electrode and the second electrode.

4. The device of claim 3, wherein the hover event comprises a glove hover event or a finger hover event.

5. The device of claim 3, wherein the controller is further configured to measure the third self-capacitance using a higher sensitivity gain than for the first self-capacitance measurement and the second self-capacitance measurement.

6. The device of claim 1, wherein the controller is implemented, at least in part, in a reprogrammable logic block.

7. The device of claim 6, wherein the controller is configured to be reprogrammed to implement different types of measurements, the types of measurements being self-capacitance measurements and mutual capacitance measurements.

8. The device of claim 1, wherein the first electrode includes a first plurality of sensing elements, and wherein the second electrode includes a second plurality of sensing elements.

9. The device of claim 1, wherein a first geometry of the first electrode and a second geometry of the second electrode are configured based on a mutual capacitance parameter associated with the capacitive sensor.

10. The device of claim 9, wherein a position of the second electrode relative to the first electrode is configured based on the mutual capacitance parameter associated with the capacitive sensor.

11. A method comprising:
measuring a first self-capacitance of a first electrode;
measuring a second self-capacitance of a second electrode;
measuring a mutual capacitance between the first electrode and the second electrode; and
determining, using a controller, whether a touch event or a hover event has occurred based on the first self-capacitance, the second self-capacitance, and the mutual capacitance, wherein the determination whether the hover event has occurred is responsive to a determination that a finger touch event, a stylus touch event, and a glove touch event have not occurred.

12. The method of claim 11, wherein the touch event is a glove touch event, and wherein the determining whether the touch event or the hover event has occurred further comprises comparing the mutual capacitance with a glove touch threshold value.

13. The method of claim 12, further comprising:
determining, using the controller, whether a finger touch event has occurred, the determining of the finger touch event comprising:
comparing the first self-capacitance with a first finger touch threshold value; and
comparing of the second self-capacitance with a second finger touch threshold value; and
determining, using the controller, whether a stylus touch event has occurred, the determining of the stylus touch event comprising:
comparing the first self-capacitance with a first stylus touch threshold value; and
comparing the second self-capacitance with a second stylus touch threshold value, wherein the second stylus touch threshold value is less than the second finger touch threshold value.

14. The method of claim 11 further comprising:
measuring a third self-capacitance of a combination of the first electrode and the second electrode; and
determining, using the controller, whether a hover event has occurred based on the third self-capacitance.

15. The method of claim 14, wherein the hover event comprises a glove hover event or a finger hover event.

16. The method of claim 11 further comprising:
identifying, using the controller, a hardware failure comprising an operational failure associated with the first electrode or the second electrode.

17. A system comprising:
a first electrode implemented in a capacitive sensor of a button;
a second electrode implemented in the capacitive sensor of the button; and
a button controller coupled to the first electrode and the second electrode, the button controller being configured to:
report a glove touch event based on a first self-capacitance measurement of the first electrode, a second self-capacitance measurement of the second electrode, and a mutual capacitance measurement of the first electrode and the second electrode;
determine whether a hover event has occurred responsive to a determination that a finger touch event, a stylus touch event, and a glove touch event have not occurred.

18. The system of claim 17, wherein the first electrode is an inner electrode included in the capacitive sensor of the button, and wherein the second electrode is an outer electrode included in the capacitive sensor of the button.

19. The system of claim 18, wherein the button controller is further configured to determine whether or not the glove touch has occurred based on a comparison of the mutual capacitance measurement with a glove touch threshold value, and
wherein the button controller is further configured to determine whether or not the glove touch has occurred in response to determining that a finger touch event has not occurred, and in response to determining that a stylus touch event has not occurred.

20. The system of claim 19, wherein the button controller is further configured to:
determine whether or not a finger touch event has occurred based on a comparison of the first self-capacitance measurement with a first finger touch threshold value and a comparison of the second self-capacitance measurement with a second finger touch threshold value;
determine whether or not a stylus touch event has occurred based on a comparison of the first self-capacitance measurement with a first stylus touch threshold value and a comparison of the second self-capacitance measurement with a second stylus touch threshold value, wherein the second stylus touch threshold value is less than the second finger touch threshold value; and
determine whether or not a hover event has occurred based on a comparison of a third self-capacitance measurement with a hover threshold value, the third self-capacitance measurement being a measured self-capacitance of a combination of the first electrode and the second electrode.
